(19) United States
(12) Patent Application Publication
(10) Pub. No.: US 2026/0043430 A1
(43) Pub. Date: Feb. 12, 2026

(54) FASTENER

(71) Applicant: Illinois Tool Works Inc., Glenview, IL (US)

(72) Inventors: Bryan Hugh MARSHALL, Sydney (AU); Alexander ANDRONIKOS, Sydney (AU)

(21) Appl. No.: 19/289,683

(22) Filed: Aug. 4, 2025

(30) Foreign Application Priority Data
Aug. 8, 2024 (AU) 2024902460
Jul. 28, 2025 (AU) 2025208565

(51) Int. Cl. F16B 25/00

(52) U.S. Cl. CPC F16B 25/0078; F16B 25/0068

(57) ABSTRACT

A fastener comprising: a shaft extending between a head of the fastener and a tip thereof; an engagement section beginning at or near the tip and extending along a portion of the shaft and having a first thread; and a longitudinal groove that extends along at least part of the engagement section, wherein the groove is configured to receive debris generated as the fastener is driven into a substrate to thereby reduce swelling of the substrate as the fastener is installed.

### PRIORITY CLAIM

This application claims priority to and the benefit of Australian Patent Application No. 2024902460, filed Aug. 8, 2024, and Australian Patent Application No. 2025208565, filed Jul. 28, 2025, the entire contents of each of which are incorporated herein by reference.

### TECHNICAL FIELD

The present disclosure relates to fasteners, and in particular self-drilling fasteners. The fasteners are particularly, although not exclusively, suitable for certain home-based applications typically undertaken by relatively inexperienced users.

### BACKGROUND

Self-drilling screws are a go-to fastener of choice in the do-it-yourself (“DIY”) industry.

As the name implies, self-drilling screws do not require a pilot hole in order to perform as a fastener. Rather, self-drilling screws include a threaded shaft that terminates in a drill-like or pointed tip, the tip being configured to drive through relatively soft substrate materials including wood, particle board, plasterboard and soft metals thus eliminating the need for a pre-drilled pilot hole.

Generally speaking, self-drilling screws are suitable for many home-based applications that are typical in the DIY industry. For example, self-drilling screws may be used in cabinetry applications to attach objects to vertical services or to attach hinges and brackets to wooden doors and the like. Self-drilling screws are also suitable for plasterboard installation, in both timber and metal stud applications. Likewise, self-drilling screws may be used in more general, timber-based applications such as decking, flooring and the like.

DIY users typically have limited access to professional grade power tools, where, unlike professional tradesman who may have a complete range of bespoke power tools for different applications at their disposal, the DIY user's generally sparse toolbox means that less than ideal tools are often shared across applications. This reduced suitability of tooling, combined with a lower level of user experience and skill, lead to an increased risk of damage to the substrate during installation, such as screw heads cracking or breaking through the surface which, in addition to being unsightly, can affect the structural integrity of the substrate. Furthermore, while self-drilling screws do not require pilot holes, increased torque demands to drive the fastener into the substrate pose challenges for lower powered tools typically favoured by DIY users, often necessitating several battery changes to complete a project.

The present disclosure was conceived with these short-comings in mind and seeks to at least in part alleviate the above-identified problems or to offer the public with a useful alternative.

### SUMMARY

In a first aspect, the present disclosure provides a fastener comprising: a shaft extending between a head of the fastener and a tip thereof; an engagement section beginning at or near the tip and extending along a portion of the shaft and having a first thread; and a longitudinal groove that extends along at least part of the engagement section, wherein the groove is configured to receive debris generated as the fastener is driven into a substrate to thereby reduce swelling of the substrate as the fastener is installed.

The groove may extend along the entire engagement section. The groove may extend beyond the engagement section. The groove may define a cutting edge that extends along a length thereof.

In a second aspect, the present disclosure provides a fastener comprising: a shaft extending between a head of the fastener and a tip thereof; an engagement section beginning at or near the tip and extending along a portion of the shaft and having a first thread; and a cutting edge that extends along at least part of the engagement section, wherein the cutting edge is configured to cut into a substrate as the fastener is driven therein to thereby reduce torque required to install the fastener.

The cutting edge may have a saw-tooth profile. Cutting of the substrate by the cutting edge may reduce splitting of the substrate when installing the fastener.

In a third aspect, the present disclosure provides a fastener comprising: a shaft extending between a head of the fastener and a tip thereof; an engagement section beginning at or near the tip and extending along a portion of the shaft and having a first thread; and an intermediate section between the engagement portion and the head, wherein the intermediate section is configured to promote controlled embedment of the head of the fastener into a substate as the fastener is driven therein.

The intermediate section may be configured to act as a governor to reduce an installation speed of the fastener as the intermediate section engages with the substrate. The intermediate section includes a second thread having a pitch that it less than a pitch of the first thread so that a speed of installation of the fastener is reduced when the second thread engages with the substrate. Alternatively, or additionally, a diameter of the intermediate section may be larger than that of the engagement portion so that a speed of installation of the fastener is reduced when the intermediate region engages with the substrate.

In some embodiments, the fastener may comprise a tapered region between the head and the shaft. The tapered region may include one or more projections substantially aligned with a longitudinal axis of the shaft and configured to improve embedment of the fastener into the substrate. The one or more projections may taper from a maximum height near the shaft to a minimum height near the head.

In some embodiments, the head may be an oversized head that is configured to reduce puncturing of the substrate during installation. The head may include a drive portion configured to receive a driving bit. The drive portion may be shaped to receive a star or cross-shaped driving bit.

In some embodiments, the tip may be configured for use with metal and/or wood substrates. The tip may be a self-drilling tip. The tip may be a pointed tip, for example a type 17 tip. Alternatively, the tip may be a drilling tip, for example a spade shaped tip.

The fastener may be configured for interior applications and include gold passivated material. Alternatively, the fastener may be configured for exterior applications and include stainless steel material.

### BRIEF DESCRIPTION OF THE DRAWINGS

The present disclosure will now be described, by way of non-limiting example only, with reference to the accompanying drawings.

FIGS. 1 and 2 are perspective and side views respectively of a fastener according to an embodiment of the present disclosure, the fastener including a shaft having a longitudinal groove.

FIG. 3 is a top view of the fastener of FIG. 1, showing a cross-shaped drive portion thereof.

FIGS. 4 and 5 are perspective and side views respectively of a fastener according to another embodiment of the present disclosure, the fastener including an oversized head.

FIG. 6 is a top view of the fastener of FIG. 4, showing a star-shaped drive portion thereof.

FIGS. 7 and 8 are perspective and side views respectively of a fastener according to another embodiment of the present disclosure, the fastener including a low-profile head.

FIG. 9 is a side view of the fastener of FIG. 7 in an example usage situation.

FIGS. 10 and 11 are perspective and side views respectively of a fastener according to another embodiment of the present disclosure, wherein the fastener includes a head having projecting ribs.

FIGS. 12 and 13 are perspective and side views respectively of a fastener according to another embodiment of the present disclosure, the fastener including a drilling tip.

FIG. 14 is a perspective view of a fastener according to another embodiment of the present disclosure, the fastener including an enlarged intermediate portion along the shaft.

FIG. 15 is a side view of the fastener of FIG. 13 in and example usage situation.

FIGS. 16 and 17 are perspective and side views respectively of a fastener according to another embodiment of the present disclosure, wherein the fastener includes a threaded intermediate portion along the shaft.

### DETAILED DESCRIPTION

In the following detailed description, reference is made to accompanying drawings which form a part of the detailed description. It will be readily understood that the aspects of the present disclosure, as generally described herein and illustrated in the drawings may be arranged, substituted, combined, separated, and designed in a wide variety of different configurations, all of which are contemplated in this disclosure.

Unless defined otherwise, all technical and scientific terms used herein have the same meaning as commonly understood by one of ordinary skill in the art to which this present disclosure belongs. Although any methods and materials similar or equivalent to those described herein can also be used in the practice or testing of the present, a limited number of the example methods and materials are described herein.

In general terms, each of the fasteners shown in the Figures are configured to reduce a reliance on operator skill and/or a requirement for specialised tooling when performing applications generally typical within a DIY type setting. The use of such fasteners may, as a consequence, provide a completed installation with an increased structural integrity and/or improve promote an improved aesthetic appearance of a finished work.

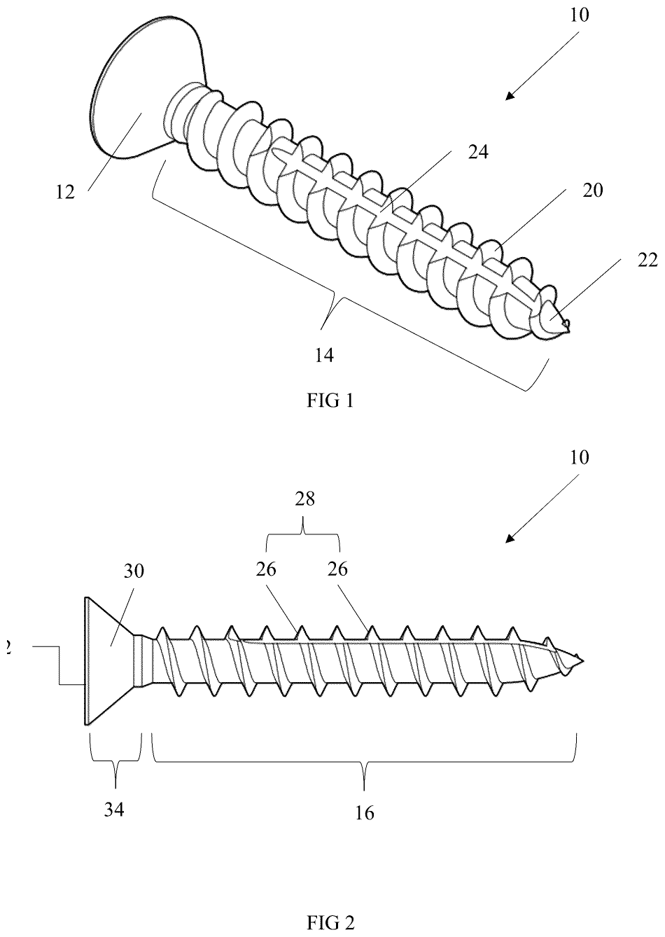

An embodiment of the present disclosure, in the form of fastener 10, will now be described in detail with reference to FIGS. 1 to 4.

With reference to FIG. 1, the fastener 10 includes a head 12 and an elongate shaft 14 that extends therefrom to define a longitudinal axis of the fastener 10. The shaft 14 includes an engagement section 16. The engagement section 16 is adapted to engage with a substrate 18 within which the faster 10 is installable, to thereby fix or otherwise secure the fastener 10 to the substrate 18. As shown, the engagement section 16 is provided in the form of a threaded portion that extends at least partway along the shaft 14. With particular reference to the illustrated embodiment, the threaded portion includes a threaded portion 20 that begins towards a tip 22 of the shaft 14 and extends substantially completely therealong, terminating at or near the head 12. The threaded portion 20 may, for example, include a single helix-shaped thread having a density of about ten threads per inch, with higher densities being suitable for metal substrates. With particular reference to timber-based applications, the threaded portion 20 may, alternatively, include dual threads arranged in an interleaving manner, so as to provide an increased effective thread density without lowering installation speed. It is understood that the thread 20 is scalable in that it can be applied to any suitable gauge of fastener 10. Trials by the applicant have found fastener 10 to be particularly suitable for general purpose applications such as installing hinges, brackets, and the like into a variety of typical household substrates including timber.

The fastener 10 includes a groove 24. The groove 24 is configured to receive debris that is generated as the fastener 10 is driven into the substrate 18. In this manner, the groove 24 provides a passage or channel along which the debris may be evacuated or otherwise displaced, thereby reducing a likelihood of the substrate 18 swelling. As shown, the groove 24 is a continuous groove that extends longitudinally along the shaft 14 and along the engagement section 16. In particular, the groove 24 begins at or near the tip 22, such that debris displaced by the tip 22 as the fastener 10 is driven into the substrate 18 is channelled into the groove 24. It is understood that while the groove 24 of the illustrated embodiment extends completely along the entire length of the engagement section 16, in other embodiments the groove 24 may extend only partway therealong.

As best shown in FIG. 2, the groove 24 is provided in the form of a V-shaped trench that extends along the central axis of the fastener 10, cutting into the thread 20 of the engagement portion 16. In this manner, the groove 24 effectively forms a series of thread cutting teeth 26 that extend along the engagement portion 16. Together, the tips of the teeth 26 provide a cutting edge 28 along the leading edge of the groove 24. The cutting edge 28 has a serrated profile so as to impart a cutting action onto the substate 18 as the fastener 10 is rotationally driven therein, reducing the drive torque required. For example, trials by the applicant have suggested torque reductions of about 30% are experienced. Reducing the drive torque is advantageous, because, for example, less power is drawn from a battery of a power tool for each fastener 10 installation. In this way, a greater number of fasteners 10 can be installed for a given battery charge, reducing the number of battery changes or re-charges that may be required to complete a job. This may be particularly beneficial for DIY users who are often reliant on power tools of limited battery capacity. Also, a reduction in required driving torque can reduce effort and fatigue if installed by a hand-driven tool such as a screwdriver.

As shown, the cutting edge 28 has a saw-tooth profile. Trials by the applicant have demonstrated that the provision of such a profiled cutting edge 28 along the shaft 14 of the fastener 10 may reduce a risk of the substrate 18 splitting. This is because the cutting edge 28 imparts a substantially constant cutting action onto the substrate 18, with each rotation of the fastener resulting in engagement of the substrate by consecutive teeth 26 of cutting edge 28. While the illustrated embodiment includes a single such groove 24, it is also contemplated that the fastener 10 may include more than one groove 24. It is understood that, while the provision of groove 24 is a particularly convenient and preferred way of providing cutting edge 28, it may be possible to provide a cutting edge 28 without a groove 24. For example, the cutting edge 28 need not be continuous along a length of the shaft 14, and may, as an alternative, be provided by off-set teeth 26 disposes along the shaft 14.

As shown in the Figures, fastener 10 includes a drilling tip 22, such as a pointed tip similar to a type 17 tip. As shown, the drilling tip 22 is formed by a conical reduction in the diameter of the shaft 14 at a distal or lower end thereof (with the opposing proximal or upper end of the shaft 14 being proximate the head 12), terminating in a pointed end. This drilling tip 22 is configured to enable the fastener 10 to pierce the substrate 18 and be driven into the substrate directly and without the need for a pilot hole. The drilling tip 22 is suitable for use with both light gauge metal and wood substrates, where the needle like geometry may assist in cleanly bursting through and deforming the metal or puncturing wood substrate so as to lead to increase a surface area for engagement with the threaded portion 20. It is understood that, depending on the desired application, the fastener 10 may be provided with several alternative tip geometries. For example, rather than the pointed or drilling tip shown in the Figures, the fastener 10 may be provided with a spade-like tip or a drill-bit like fluted tip or application specific geometry.

The head 12 of the fastener 10 will now be described. As shown, the head 12 includes a head body 30 having a substantially flat disc shaped upper surface 32 that is arranged to be sat substantially flush within the substrate 18. A tapered region 24 is provided under the head body 30, projecting reducingly towards the shaft 14. The tapered region 34, may, for example as shown, have a countersunk profile that tapers substantially linearly from the enlarged diameter of the upper surface 32 of the head 12 towards the reduced diameter of the shaft 14.

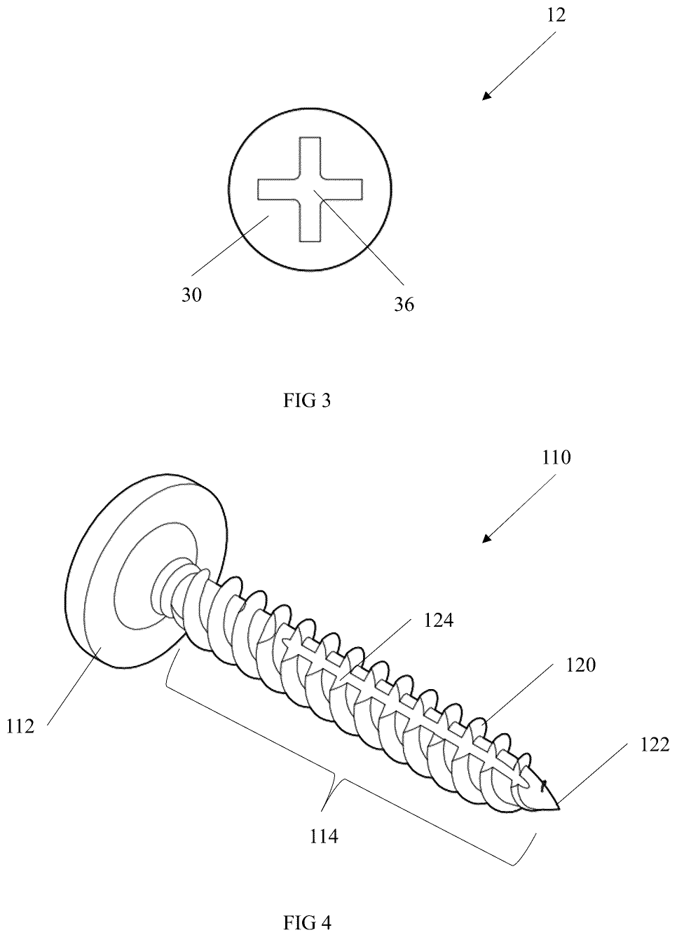

It is understood that the upper surface 32 of the head 12 includes a drive portion 36. For example, the drive portion 36 may be provided in the form of a cavity that extends down from the upper surface 32 and into the head body 30. The drive portion 36 is configured to receive a driving bit of a power tool. In particular, as shown in FIG. 3, the drive portion 36 is preferably shaped to receive a 4-pointed cross shaped driving bit that would be familiar to the home DIY user, ensuring that the user does not need to source particular, less common, bits and the like in order to use fastener 10. Such drive portion 36 (as shown) is provided by way of example only and that other drive portions shaped to receive other drive bits are also contemplated.

Depending on application, it is contemplated that at least a portion of the fastener 10 may be formed from a gold passivated material. Such material may be particularly appropriate for internal applications. Alternatively, when used outdoors, it may be preferable to form at least a portion of fastener 10 from a stainless steel or similar corrosion resistant material.

An alternative embodiment of the present disclosure, in the form of fastener 110, will now be described with reference to FIGS. 4 to 6. For clarity, similar components and functional analogues will be described using similar terminology and numerical references.

Fastener 110 is generally similar to fastener 10 and may include any combination of features as described with respect thereto. Notably, however, fastener 110 has been configured to have particular application as a lap or stitching screw, where it may be used to “stitch” or otherwise connect together sheets of substrate 18 including timber and light gauge metals in close proximity to one another, for example in overlapping or abutting fashion. Such fasteners 110 may, therefore, be particular useful when installing flashing, trim, gutters, and the like which may fall within the remit of the DIY user.

As shown in FIGS. 4 and 5, the fastener 110 includes an engagement section 116 that extends from a pointed or needle-like tip 122 substantially all the way along shaft 114 to head 112. In this manner, thread 120 extends to a tapered region 134 under the head 112, said tapered region 134 being provided in the form of a rounded fillet so as to provide a recess for engagement of a drive tool. Together, the reduced length of the tapered region and full length of thread 120 enable adjacent or otherwise neighbouring substrate sheets 18 to be locked into position.

Further, as best shown in FIG. 5, the head 112 of the fastener 110 is pan-shaped, including large or otherwise over-sized upper surface 132. The oversized head 112 provides an increased clamping area that engages against the substrate 18. Such increased surface area reduces the risk of the head 112 of the fastener 110 puncturing or otherwise breaking through the surface of the substrate 18, which may be of particular risk when installing thin sheets of timber material. The oversized upper surface 132 is provided by a low-profile or wafer like body 130, such that, when installed, the head may sit substantially flush with the substrate 18 and not project overtly outwardly therefrom. While not clear from the Figures, it is contemplated the head 112 may be coated or otherwise coloured so as to be sympathetic to a finish of the material being fastened.

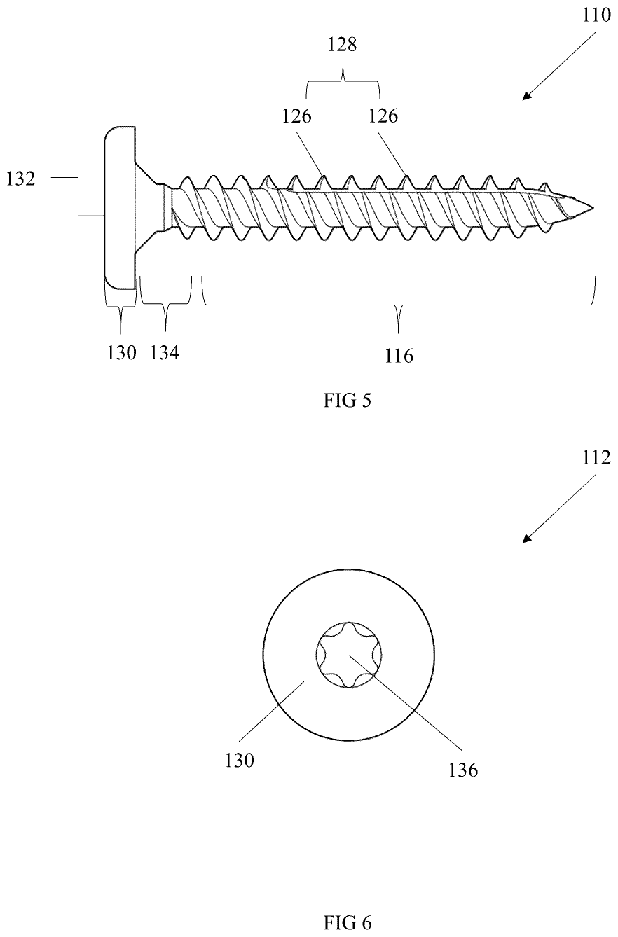

Moving to FIG. 6, it should be understood that fastener 110 may be provided with a drive portion 136 that is shaped to accommodate and engage with a 6-point star shaped male driving bit. Such driving portion 136 is particularly suited to applications requiring solid engagement with the driving tool, as may be necessary when driving fastener 110 through two, overlapping, sheets of substrate 18. It is understood, however, that fastener 110 is not limited to such drive portion 134 and that other drive portions 136 shaped to receive other bit types are also contemplated.

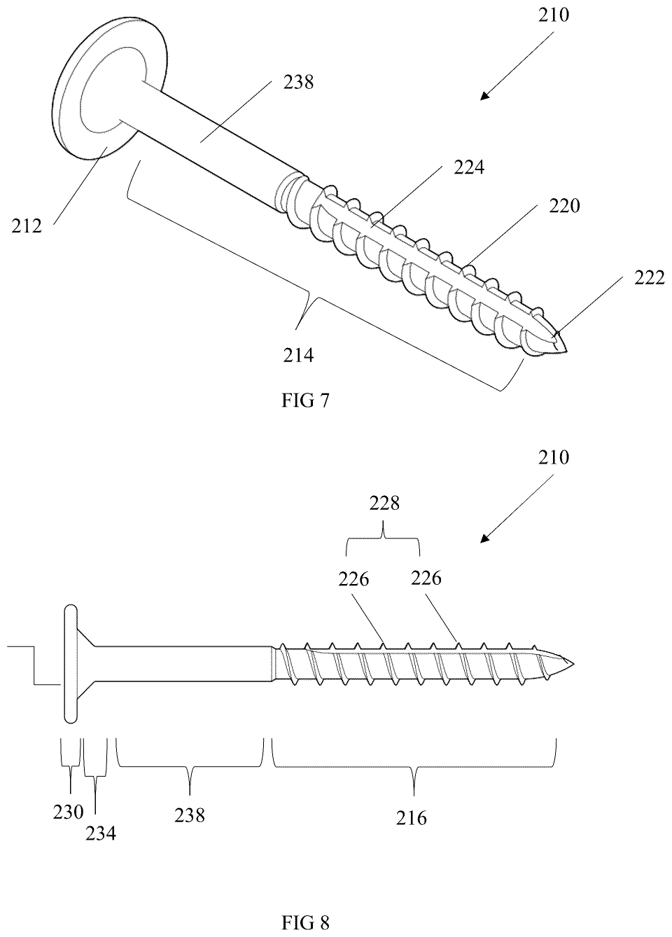

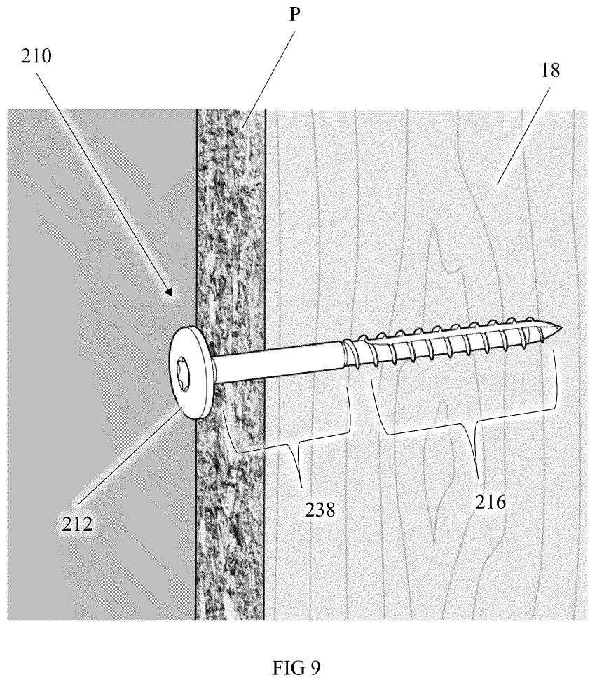

A further alternative embodiment of the present disclosure, in the form of fastener 210, will now be described with reference to FIGS. 7 and 8. For clarity, similar components and functional analogues will be described using similar terminology and numerical references.

Fastener 210 is generally similar to fastener 110 and may include any combination of features as described with respect thereto. Notably, however, fastener 210 has been configured to have particular application as a cabinet screw, where it may be used to secure or otherwise mount items P such as cabinetry assemblies or panels to vertical wall surfaces and framework.

To this end, shaft 214 of fastener 210 includes an intermediate section 238 that is disposed between the head 212 and engagement section 216 thereof. The intermediate section 238 may be configured as a shank that serves as a spacer that extends an overall length of the shaft 214, such that, when installed, the intermediate section 238 extends through the body of the item to be mounted to the wall surface while the engagement section 216 is embedded within the substrate 18 of the wall surface, securing the item thereto. While not shown, it is understood that groove 224 of fastener 210 may extend beyond the engagement section 216 and at least part-way along the intermediate section 238. Such arrangement may be beneficial in applications where a clamping action is required to attach a panel or assembly to a secure surface or substrate 18.

Fastener 210 also includes an oversized, pan-shaped head 212. The pan-shaped head 212 includes a large diameter upper surface 232 having a low-profile body 230 working as a clamp that spreads a load of the potentially heavy item while also lying substantially flush against a surface of the item. FIG. 9 shows the fastener 210 in-situ. As depicted in the Figure, an underside of the body 230 of the head 212 of the fastener 210 rests or otherwise abuts against an outer surface of the item P (which, as shown, is a panel that may, for example, form part of a piece of cabinetry). The low-profile nature of the body 230 means that the upper surface 232 of the head 212 does not prominently project from the outer surface of the item P. Meanwhile, the engagement section 216 is spaced away from the head 212 by the shank portion 238 such that the embedded within the substrate 18 (which, as shown, is a timber stud), enabling the fastener 210 to thereby serve as a clamp and secure the item P to the substrate 18.

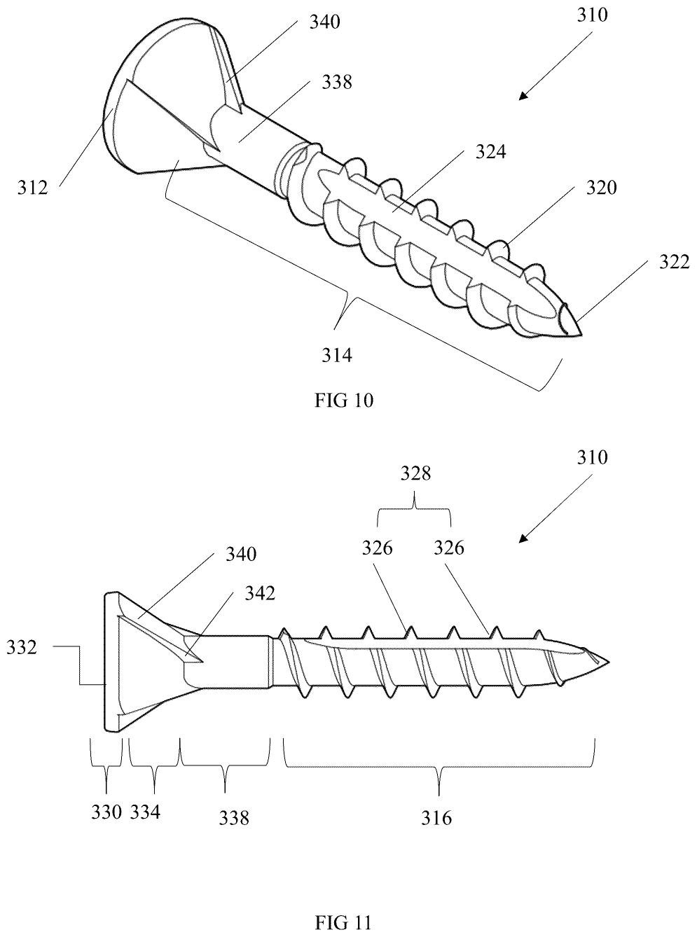

A further alternative embodiment of the present disclosure, in the form of fastener 310, will now be described with reference to FIGS. 10 and 11. For clarity, similar components and functional analogues will be described using similar terminology and numerical references.

Fastener 310 is generally similar to fastener 210 and may include any combination of features as described with respect thereto. Notably, however, fastener 310 has been configured to have particular application as a particle board screw for use with composite timbers such as laminated board, chip board MDF and the like, with the fastener 310 being configured to have improved resistance to pull-out.

In this regard, fastener 310 is provided with a head 312 that includes a plurality of projections 340 that extend outwardly from the body 330 and/or tapered section 332. The rib-like projections 340 are arranged to provide a cutting mechanism that is analogous to that of cutting edge 328. In this way, it is understood that the cutting edge 328 of the fastener 310 is provided by a combination of both groove 324 and ribs 340. In particular, the ribs 340 are configured to provide better embedment into the substrate 18 by cutting the substrate material as opposed to compressing or disrupting it, thereby minimising displacement of debris.

As shown, the ribs have a sawtooth profile that is configured to provide an improved finish, with the head 312 lying flush or countersunk within the substrate 18. In particular, the ribs 340 carry a leading or cutting edge 342 which is more significant towards the shaft 314 of the fastener 310 than the head 312 thereof. Put differently, the leading edge 342 of the ribs 340 tapers away from a maximum height at or near the engagement section 316 to a minimum height at or near the perimeter of the upper surface 330 of head 312. The leading edge 342 of the ribs 340 is configured to create a recess in the substrate 18, enabling the head 312 to sit flush therein with reduced risk of the material cracking, alleviating a reliance on user skill to install the screw flush with the surface of the substrate 18.

Trials by the applicant have shown that the rib arrangement 340 may assist in reducing the substrate 18 from opening up as the fastener 310 is fixed to an edge of the substrate, thereby mitigating against cracking. Also, the ribs may assist in providing tactile feedback to the user to indicate a correct depth with which to insert the fastener 310 into the substrate 18, guarding against the head going through the face of the substrate 18 which may result in a structurally unsound installation.

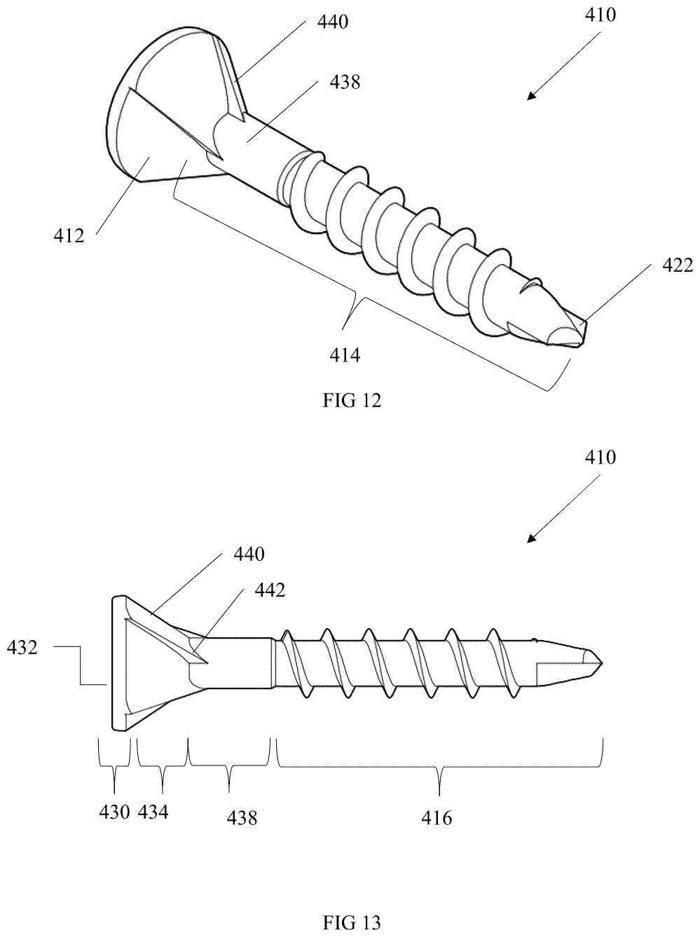

A further alternative embodiment of the present disclosure, in the form of fastener 410, will now be described with reference to FIGS. 12 and 13. For clarity, similar components and functional analogues will be described using similar terminology and numerical references.

Fastener 410 is generally similar to fastener 310 and may include any combination of features as described with respect thereto. Notably, however, fastener 410 is provided with a spade-shaped tip 422. The spade shaped tip 422 is arranged to replicate an action of a pilot drill cutting into a substrate material 18 to provide optimum thread engagement while reducing a risk of cracking or splitting the substrate 18. Trials by the applicant have shown that the spade tip 422 may be particularly suitable for boring comparatively large holes into wooden substrates 18 and may create an optimal hole diameter for improved thread engagement. The scooping action provided by the spade shaped tip 422 may obviate a need to provide a groove 424 along which debris may be channelled. This being said, depending on the substrate 18 material, it may be beneficial to provide a groove 424 in conjunction with spade-shaped tip 422. Such arrangement is understood to be contemplated within this disclosure.

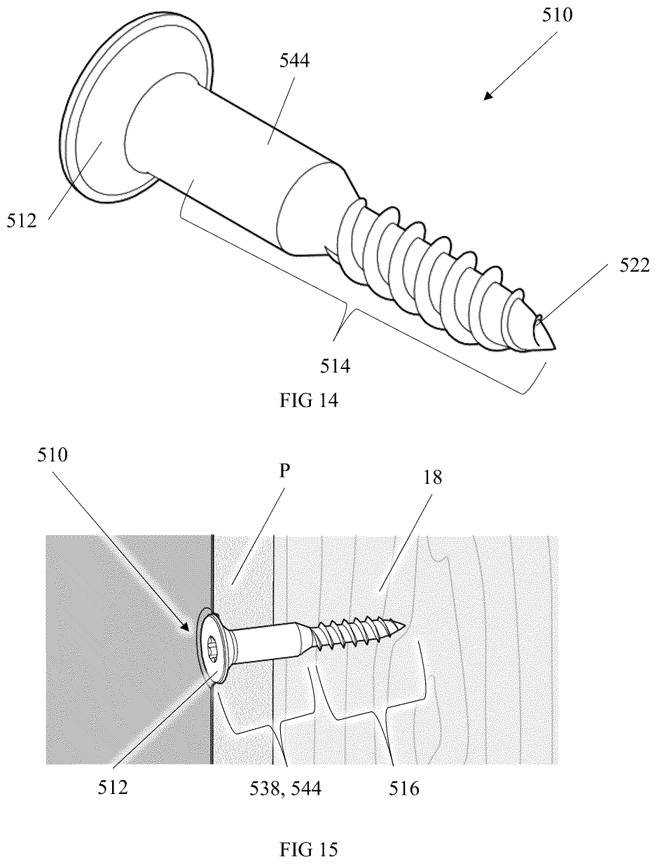

Moving now to FIGS. 14 to 17, which show further alternative embodiments of the present disclosure, in the form of fasteners 510 and 610, which include respective intermediate sections that promote controlled embedment of the head into a substrate, reducing a likelihood of the head breaking therethrough. For clarity, similar components and functional analogues will be described using similar terminology and numerical references.

Beginning with FIGS. 14 and 15 which show fastener 510. As shown, the intermediate section 538 has an enlarged diameter when compared to that of the remainder of the shaft 514 (including engagement section 516). This enlarged diameter section 538 acts as a governor 544 to reduce an installation speed of the fastener 510 as the intermediate section 538 engages with an underlying material.

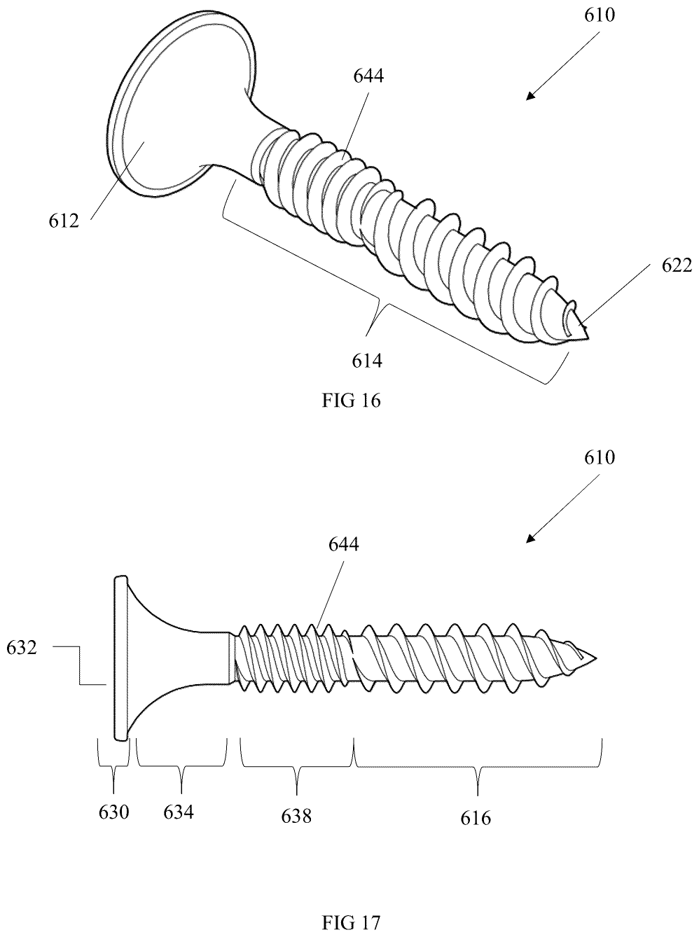

Such fastener 510 has particular use in plasterboard applications, as shown in FIG. 15. In particular, FIG. 16 demonstrates a situation where it is often desirable to install the fastener 510 such that the head 512 thereof rests slightly below an external surface of a plaster sheet P that is being attached to an underlying substrate in the form of a wall stud 18. In such application, it is important to ensure that the head 512 of the fastener 510 does not puncture the plasterboard P that is being secured to the stud, which would reduce the integrity of the fixing. In particular, as best shown in FIG. 15, as it becomes increasingly engaged with the underlying stud 18, the enlarged intermediate section 538 provides increased resistance to forward movement of the fastener 510, thereby reducing a risk of the head bursting through the face of the plasterboard P. The increased resistance provides a tactile cue to the user and extends the optimal window within which to cease drive onto the fastener 510. Put differently, the intermediate section 538 slows down the fastener towards the end of its travel, extending the optimal window within which to cease drive onto the fastener 510 and thereby reducing the likelihood of the head 512 being driven deeper then desired.

While not shown in the Figures, it is understood that fastener 510 may include any of the features of fasteners 10, 110, 210, 310 and 410 as described herein, including but not limited to a groove 524 and/or cutting edge 528.

Moving now to FIGS. 16 and 17, which show fastener 610. Fastener 610 is generally similar to fastener 510 and may include any of the features thereof. Notably, while performing a substantially analogous function, the intermediate section 638 of fastener 610 includes a governor 644 in the form of a second threaded portion. This second thread has an increased density than that of the first thread 620 of the engagement portion 616. Put differently, the pitch of the second threaded portion of fastener 610 is less than that of the first threaded portion 620. In this manner, as the second threaded portion 644 becomes engaged with the underlying stud, forward movement of the fastener 610 is reduced and feedback is provided to the user, reducing the risk of the head bursting through the face of the plasterboard.

As best shown in FIG. 17, fastener 610 includes a bugle shaped head 612. Specifically, the tapered region 634 has a bugle-like shape that provides a smooth transition between the diameter of the upper surface 632 and that of the shaft 614. This shape can be advantageous when compared to more conventional straight or linear countersink profiles as the comparatively shallow ramp angle reduces the likelihood of splitting of the substrate. It is understood that fastener 510 may also include a similar head geometry.

Summarily, it is understood that embodiments of the present disclosure as described herein provides alternatives to conventional self-drilling fasteners and may result in improved levels of useability that are advantageous for the DIY market. For example, some embodiments of the present disclosure include a groove that may mitigate against swelling of thin substrates, providing a channel that directs debris outwardly from the substrate. Further, a cutting edge provided along a shaft and/or within the head of other embodiments may lower drive torque requirements, which may assist in reduce fatigue and/or enable said fasteners to be installed using lower-powered power tools. Further, the provision of an intermediate portion that acts as a governor can provide tactile feedback to a user while also reducing a forward installation speed as the fastener nears the end of its travel, reducing a risk of the fastener being driven further than desired.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### LEGEND

| | |
|---|---|
| 10 | Fastener |
| 12 | Head |
| 14 | Shaft |
| 16 | Engagement section |
| 18 | Substrate |
| 20 | Thread |
| 22 | Tip |
| 24 | Groove |
| 26 | Teeth |
| 28 | Cutting edge |
| 30 | Head body |
| 32 | Upper surface of head |
| 34 | Tapered region |
| 36 | Drive portion |
| 110 | Fastener |
| 210 | Fastener |
| 238 | Intermediate section |
| 310 | Fastener |
| 340 | Projections |
| 342 | Leading edge |
| 410 | Fastener |
| 510 | Fastener |
| 544 | Governor |
| 610 | Fastener |
| P | Secured item |

1. A fastener comprising:
a head;
a tip; and
a shaft connected to and extending between the head and the tip, the shaft including an engagement section beginning at or near the tip and extending along a portion of the shaft and having a first thread, the shaft defining a longitudinal groove that extends along at least part of the engagement section,
wherein the longitudinal groove is configured to receive debris generated as the fastener is driven into a substrate to thereby reduce swelling of the substrate as the fastener is installed in the substrate.

2. The fastener of claim 1, wherein the longitudinal groove extends along the entire engagement section.

3. The fastener of claim 1, wherein the longitudinal groove extends beyond the engagement section.

4. The fastener of claim 1, wherein the shaft defies defines a cutting edge that extends along a length of the longitudinal groove.

5. A fastener comprising:
a head;
a tip; and
a shaft connected to and extending between the head and the tip, the shaft including:
an engagement section beginning at or near the tip and extending along a portion of the shaft and having a first thread, and
a cutting edge that extends along at least part of the engagement section,
wherein the cutting edge is configured to cut into a substrate as the fastener is driven therein to thereby reduce torque required to install the fastener.

6. The fastener of claim 5, wherein the cutting edge has a saw-tooth profile.

7. The fastener of claim 5, wherein the cutting edge is configured such that cutting of the substrate by the cutting edge reduces splitting of the substrate when installing the fastener.

8. A fastener comprising:
a head;
a tip; and
a shaft connected to and extending between the head and the tip, the shaft including
an engagement section beginning at or near the tip and extending along a portion of the shaft and having a first thread, and
an intermediate section between the engagement portion and the head,
wherein the intermediate section is configured to promote controlled embedment of the head of the fastener into a substate as the fastener is driven therein.

9. The fastener of claim 8, wherein the intermediate section is configured to act as a governor to reduce an installation speed of the fastener as the intermediate section engages with the substrate.

10. The fastener of claim 9, wherein the intermediate section includes a second thread having a pitch that it less than a pitch of the first thread so that a speed of installation of the fastener is reduced when the second thread engages with the substrate.

11. The fastener of claim 9, wherein a diameter of the intermediate section is larger than that of the engagement portion so that a speed of installation of the fastener is reduced when the intermediate region engages with the substrate.

12. The fastener of claim 8, which includes a tapered region between the head and the shaft.

13. The fastener of claim 12, wherein the tapered region includes one or more projections substantially aligned with a longitudinal axis of the shaft and configured to improve embedment of the fastener into the substrate.

14. The fastener of claim 13, wherein the one or more projections taper from a maximum height near the shaft to a minimum height near the head.

15. The fastener of claim 8, wherein the head is an oversized head that is configured to reduce puncturing of the substrate during installation.

16. The fastener of claim 8, wherein the head includes a drive portion configured to receive a driving bit.

17. The fastener of claim 8, wherein the tip is a self-drilling tip.

18. The fastener of claim 8, wherein the tip is a pointed tip.

19. The fastener of claim 8, which includes gold passivated material.

20. The fastener of claim 8, which includes stainless steel material.
